(19) United States
(12) Patent Application Publication
(10) Pub. No.: US 2015/0156193 A1
(43) Pub. Date: Jun. 4, 2015

(54) CREATING AND MANAGING CERTIFICATES IN A ROLE-BASED CERTIFICATE STORE

(71) Applicant: Microsoft Corporation, Redmond, WA (US)

(72) Inventor: Hong Wei Chen, Kirkland, WA (US)

(73) Assignee: Microsoft Corporation, Redmond, WA (US)

(21) Appl. No.: 14/094,461

(22) Filed: Dec. 2, 2013

(51) Int. Cl. H04L 29/06

(52) U.S. Cl. CPC H04L 63/0823

(57) ABSTRACT

Embodiments are directed to managing shared certificates of a role certificate store, accessing and implementing certificates provided by a role certificate store and to managing role-based shared certificates using a role certificate store. In one scenario, a computer system establishes a role certificate store. The role certificate store is configured to store role-based shared certificates, where each role-based shared certificate corresponds to instances of a specified role. The computer system receives a request for a role-based shared certificate from an instance of the specified role, where the request is redirected from a local data store to the role certificate store. The computer system then verifies that the request was received from an instance of the specified role and sends the requested role-based shared certificate to the role instance.

### BACKGROUND

Computer databases have long been used to store and provide access to data. Computer databases often implement roles. These roles are assigned certificates so that instances of the roles can conduct transactions associated with the roles. These certificates are designed to expire after a certain amount of time. As such, the certificates need to be updated or renewed periodically. This renewal process can consume large amounts of time and resources, especially in cases where many hundreds or thousands of certificates are in use.

### BRIEF SUMMARY

Embodiments described herein are directed to managing shared certificates of a role certificate store, accessing and implementing certificates provided by a role certificate store and to managing role-based shared certificates using a role certificate store. In one embodiment, a computer system establishes a role certificate store. The role certificate store is configured to store role-based shared certificates, where each role-based shared certificate corresponds to instances of a specified role. The computer system receives a request for a role-based shared certificate from an instance of the specified role, where the request is redirected from a local data store to the role certificate store. The computer system then verifies that the request was received from an instance of the specified role and sends the requested role-based shared certificate to the role instance.

In another embodiment, a computer system accesses and implements certificates provided by a role certificate store. The computer system sends a request for a role-based shared certificate to a role certificate store. The role certificate store is configured to store role-based shared certificates that each correspond to a specified role. The request further identifies a specified role to which the role instance is associated. The computer system receives a role-based shared certificate from the role certificate store, where the role certificate store has verified that the role instance is associated with the specified role. The specified role itself is associated with the role-based shared certificate. The computer system then performs one or more role-specific functions using the role-based shared certificate.

In yet another embodiment, a computer system manages role-based shared certificates using a role certificate store. The computer system receives a request at a role certificate store to perform management actions on a role-based shared certificate stored in the role certificate store. The role certificate store is configured to store multiple shared certificates for at least one specified role. The computer system verifies that the request was received from a role instance that is authorized to perform the one or more management actions and, upon determining that the request was received from an authorized role instance, performs the management actions on the specified role-based shared certificate at the role certificate store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including managing shared certificates of a role certificate store.

FIG. 2 illustrates a flowchart of an example method for managing shared certificates of a role certificate store.

FIG. 3 illustrates a flowchart of an example method for accessing and implementing certificates provided by a role certificate store.

FIG. 4 illustrates a flowchart of an example method for managing role-based shared certificates using a role certificate store.

FIG. 5 illustrates an embodiment in which shared certificates are distributed among role instances.

FIG. 6 illustrates an embodiment in which a role certificate store includes shared certificates for multiple different roles.

### DETAILED DESCRIPTION

Embodiments described herein are directed to managing shared certificates of a role certificate store, accessing and implementing certificates provided by a role certificate store and to managing role-based shared certificates using a role certificate store. In one embodiment, a computer system establishes a role certificate store. The role certificate store is configured to store role-based shared certificates, where each role-based shared certificate corresponds to instances of a specified role. The computer system receives a request for a role-based shared certificate from an instance of the specified role, where the request is redirected from a local data store to the role certificate store. The computer system then verifies that the request was received from an instance of the specified role and sends the requested role-based shared certificate to the role instance.

In another embodiment, a computer system accesses and implements certificates provided by a role certificate store. The computer system sends a request for a role-based shared certificate to a role certificate store. The role certificate store is configured to store role-based shared certificates that each correspond to a specified role. The request further identifies a specified role to which the role instance is associated. The computer system receives a role-based shared certificate from the role certificate store, where the role certificate store has verified that the role instance is associated with the specified role. The specified role itself is associated with the role-based shared certificate. The computer system then performs one or more role-specific functions using the role-based shared certificate.

In yet another embodiment, a computer system manages role-based shared certificates using a role certificate store. The computer system receives a request at a role certificate store to perform management actions on a role-based shared certificate stored in the role certificate store. The role certificate store is configured to store multiple shared certificates for at least one specified role. The computer system verifies that the request was received from a role instance that is authorized to perform the one or more management actions and, upon determining that the request was received from an authorized role instance, performs the management actions on the specified role-based shared certificate at the role certificate store.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

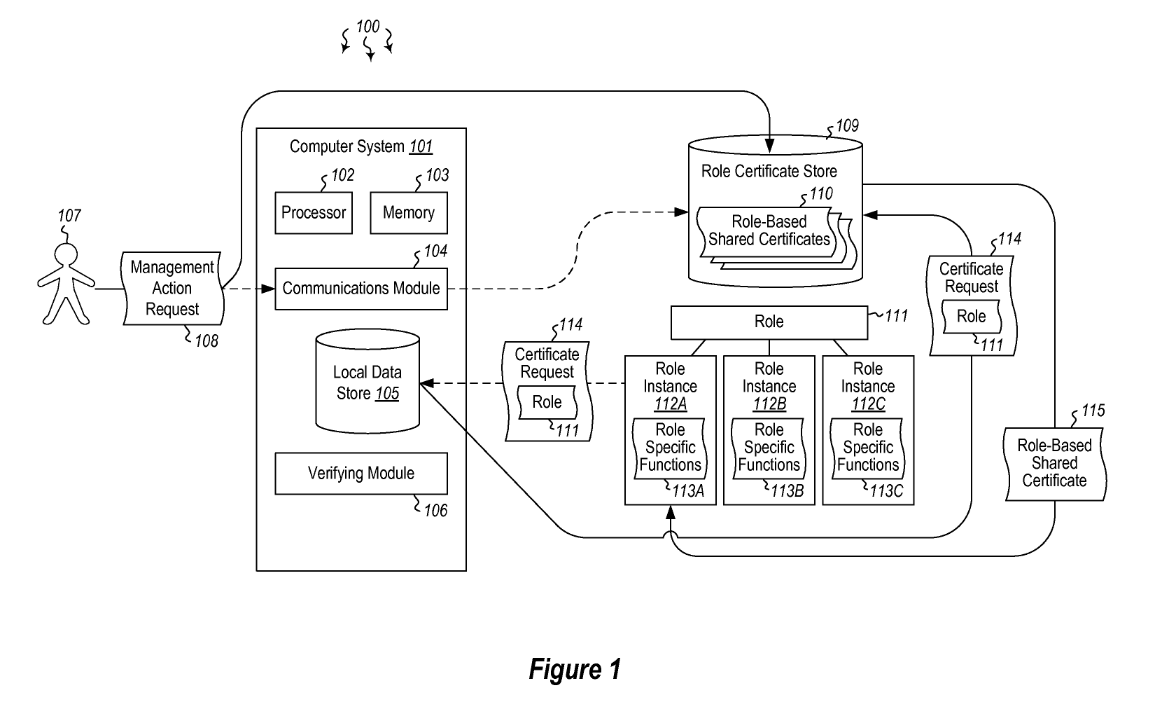

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system includes various modules for performing a variety of different functions. For instance, the communications module 104 may be used to communicate with other computer systems or data stores, including role instances 112A-C and/or role certificate store 109. The role certificate store 109 may be configured to store role-based certificates 110. These certificates may correspond to a specific role 111. The role may be any type of administrative, end-user or other type of role. The role may grant users or instances of that role certain rights or privileges. For instance, members of a role may be able to access certain portions of data or applications that are unavailable to non-members.

The role instances may, at least in some cases, comprise computer systems. For instance, role instance 112A may comprise a local computer system. Role instance 112B may comprise a mobile computer system, and role instance 112C may comprises a virtual machine. Other role instances are possible, and the above are merely examples of role instances. Moreover, while three role instances are depicted in FIG. 1, it will be understood that substantially any number of role instances may be used in conjunction with a role certificate store. The role certificate store itself 109 may be hosted on a computer system (e.g. computer system 101), on a database (distributed or local), or on a role instance (or distributed over a plurality of role instances). Regardless of where the role certificate store 109 is hosted, it is accessible by the role instances via a wired or wireless network. In this manner, role instances may request and receive role-based shared certificates 110.

These role-based shared certificates 110 may be shared by all members (or a subset thereof) of a role 111. Thus, role instances 112A-C may each access and receive a shared certificate to perform role-based functions. If, for example, the role instances 112A-C were all computer systems that were assigned to similar workers in a business entity, the role instances would be able to indicate and verify that they were indeed members of the role, and request and receive corresponding role-based certificates 115. In some cases, the role instances may first send their certificate requests 114 to a local data store (e.g. data store 105). The verifying module 106 may look at the role 111 indicated by the role instance (e.g. 112A) and verify that the role instance is indeed a member of that role. If such is the case, the local data store may forward the request 114 to the role certificate store 109 with an indication that the role instance is authorized and that a role-based certificate can be issued to it. Upon receiving the role-based certificate 115, the role instance 112A may perform one or more role-specific functions 113A that are available to members of that role 111.

At least in some cases, instances of a role may share identical or nearly identical characteristics. The role instances may be referred to herein as instance groups or clusters. The role certificates may be shared with other instances of a role. In some cases, other certificates may be implemented which are not shared among instances. These are “non-role certificates”, or “local” certificates. Local certificates are typically saved at a local computer system's (secure) data store. Role-based shared certificates may be saved locally or at a place external to the individual instance (e.g. the role certificate store 109). The role certificate store may be hosted in a location known to all instances of a cluster, but may be accessible only to those instances that belong to the particular role. Local certificates and role-based shared certificates may thus have different store paths.

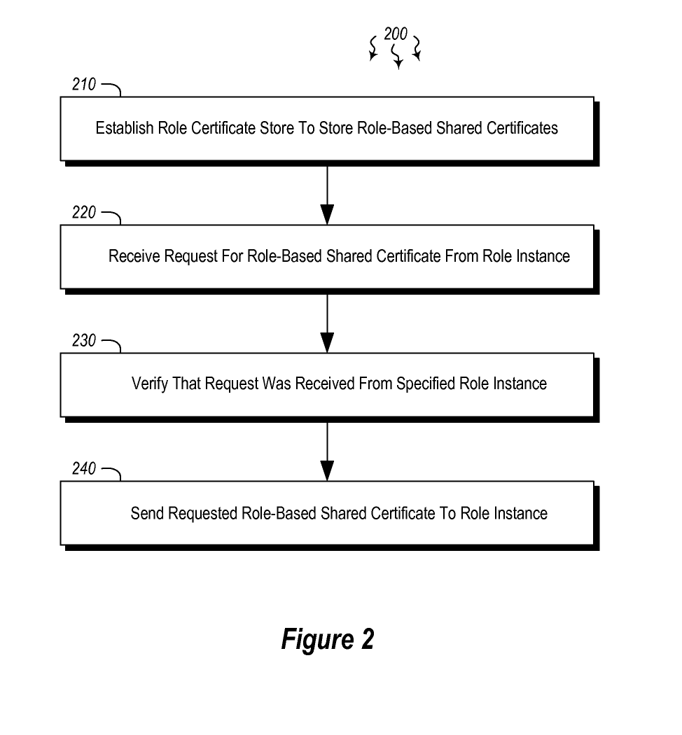

Role certificates may be managed (e.g. by administrative users) in the role certificate store 109. The administrative or other authorized user may create, update, modify or remove certificates from the role certificate store. Whenever a role instance needs to access a role-based shared certificate 110, it checks the store path first. If it is for a role-based shared certificate, the role instance will access the role certificate store 109. This certificate access from the role instance (e.g. 112A) to the role certificate store is usually encrypted, and may be set up using a password or pass phase. Role instances may implement a synchronization to pull certificates from the role certificate store 109 and, at least in some cases, proxy them locally, either in predefined intervals (e.g. with some freshness indication such as a last modified time stamp), or using a pull-on-demand command issued by a user such as a system administrator. The above-described model may also apply to non-cluster heterogeneous systems, where nodes and devices are able to reference shared certificates provided by group or enterprise level certificate stores. These concepts will be explained further below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for managing shared certificates of a role certificate store. The method 200 will now be described with frequent reference to the components and data of environment 100.

Method 200 includes an act of establishing a role certificate store, the role certificate store being configured to store one or more role-based shared certificates, each role-based shared certificate corresponding to one or more instances of a specified role; (act 210). For example, computer system 101 may establish role certificate store 109 which stores role-based certificates 110 for at least one role. The role may be assigned to various users, computer system or virtual machines, and may allow that entity to perform role-specific functions, along with other functions that are not role-specific. The role-specific functions (e.g. 113A-C) may include any type of software or other functions, including accessing data that is only provided to role members, accessing applications that are only provided to role members, making changes to settings or applications that are only permitted if the entity is a member of the role 111.

Each role-based shared certificate may be stored with a unique identifier. As such, each role-based shared certificate may be identified and accessed using the unique identifier. The role-based shared certificates may be physically stored on a single machine (which may be local or remote), or may be stored in a distributed manner over a plurality of computer systems (e.g. in the cloud), over a plurality of virtual machines and/or other data stores. Accordingly, regardless of where the certificate is actually stored, it may be identified and accessed using its unique identifier. Similarly, each role instance may be a local computer system, a distributed computer system, a mobile computing system (such as a smart phone or tablet), a user or other entity. The role-based shared certificates are shared by each instance associated with the role, regardless of where the role instance is located.

Method 200 next includes an act of receiving a request for a role-based shared certificate from an instance of the specified role, the request being redirected from a local data store to the role certificate store (act 220). Role instances may send certificate requests to local data stores (e.g. local data store 105 or a data store that is on the role instance itself). The local data store may indicate that it does not have the requested certificate, and may redirect the certificate request 114 to the role certificate store 109. In some cases, the local computer system may be used as a proxy to cache the role-based shared certificate. In such cases, because the role-based shared certificate is stored in a local cache, the request would be satisfied from the cached copy, and would not be forwarded to the role certificate store 109. In cases where local copies of the role-based shared certificate are cached, an agent application may be implemented to determine when to replace or refresh the local copy of the role-based shared certificate. The agent application may, for example, monitor the expiration or other status of the certificate and ensure that the certificate is updated before expiration.

Method 200 further includes an act of verifying that the request was received from an instance of the specified role (act 230). The verifying module 106 of computer system 101 may be used to verify that the certificate request 114 was actually received from an instance of role 111. The verifying module may look at metadata, unique identifiers, authentication information or other data that indicates which role the instance is a member of Upon determining that the certificate request 114 was received from an instance of role 111 (e.g. role instance 112B), the requested role-based shared certificate 115 is sent to the role instance (act 240). The role instance that sent the request (112B in the example above) may then perform role-specific functions 113B that are available to members of that role 111. If role instance 112C were to send a certificate request for a role-based shared certificate, it would receive the same (or substantially the same) role-based shared certificate 115 as was sent to role instance 112B, and would be able to perform the same or similar role-specific functions as those afforded to role instance 112B. As such, role-specific functions 113A-C may be the same or substantially the same for each role instance that is a member of role 111.

In some embodiments, local certificates may be implemented in addition to role-based certificates. The local certificates may be stored locally on the computer system to which the role instance is associated. Thus, for example, if role instance 112C is a computer system associated with role 111, one or more local certificates may be stored on that computer system and used in addition to or in conjunction with the role-based shared certificates 110. The role instances may access local certificates on the local computer system and use them to perform certain functions. As such, role instances may implement both local and role-based shared certificates to perform specific functions or sets of functions. These local certificates may be node-specific (i.e. computer system-specific) and, furthermore, the local certificates may be non-shareable (i.e. only valid for that computer system). The local and role-based shared certificates may each include unique identifiers that are used to differentiate between the certificates. These unique identifiers may be used to distinguish between local and role-based shared certificates when performing or attempting to perform desired functionality.

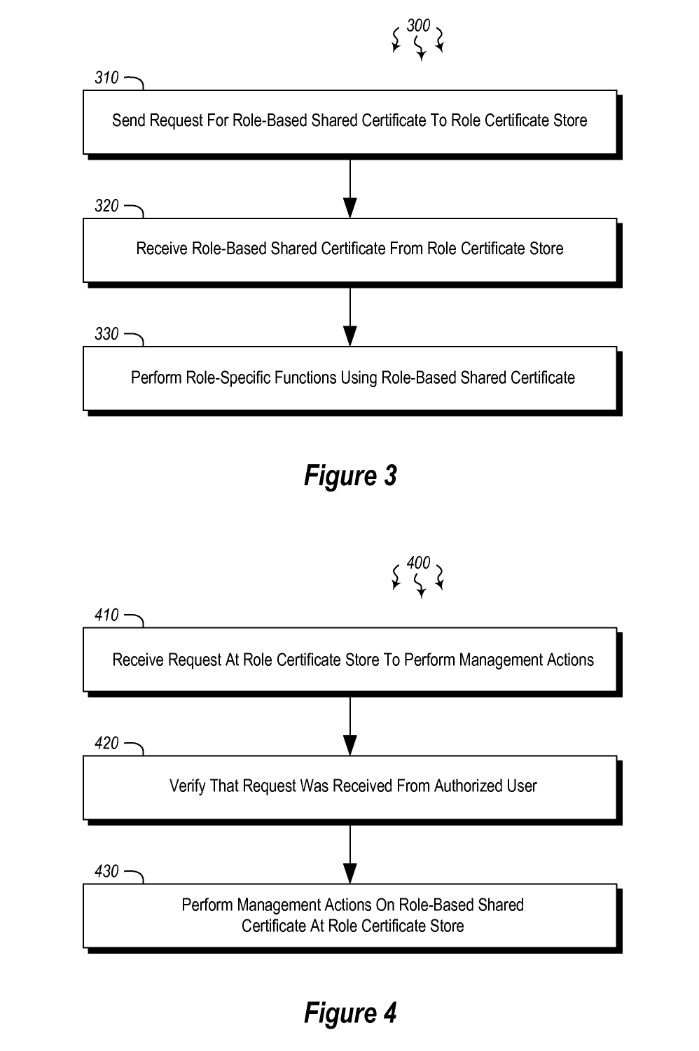

Turning now to FIG. 3, a flowchart is illustrated of a method 300 for accessing and implementing certificates provided by a role certificate store. The method 300 will now be described with frequent reference to the components and data of environment 100.

Method 300 includes an act of a role instance sending a request for a role-based shared certificate to a role certificate store, the role certificate store being configured to store role-based shared certificates that each correspond to a specified role, the request identifying a specified role to which the role instance is associated (act 310). For example, role instance 112A may send certificate request 114 (either directly or indirectly) to role certificate store 109. The role certificate store stores role-based shared certificates that each correspond to a particular role (e.g. role 111). The certificate request 114 sent by the role instance may specify the role 111 to which it is associated. The role certificate request (and any role certificates sent back in return) may be sent over secured communication to prevent against unauthorized access.

Method 300 includes an act of receiving a role-based shared certificate from the role certificate store, the role certificate store having verified that the role instance is associated with the specified role, the specified role itself being associated with the role-based shared certificate (act 320). Once the role instance has been verified (e.g. by module 106) and has received the requested role-based shared certificate 115, the role instance (e.g. 112C) can perform or more role-specific functions using the role-based shared certificate (act 330).

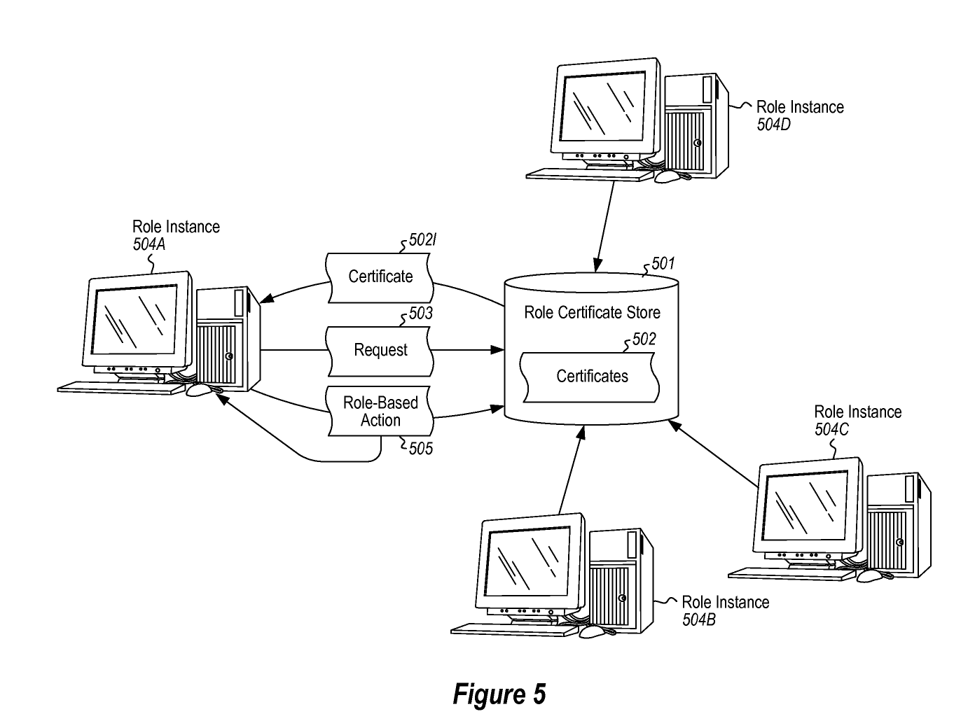

For example, as shown in FIG. 5, a role certificate store 501 may be accessible by a plurality of different role instances (504A-D). Each role instance may request and receive role-based shared certificates 502 from the role certificate store 501. Thus, for example, role instance 504A may send certificate request 503 to role certificate store 501. The role certificate store may send a role-based shared certificate 5021 that corresponds to the role to which the role instance 504A is associated. The role instance 504A may then perform role-specific functions including role-based action 505. The role-based action may be any action that is specific to that role. The role-based action may be sent to the role certificate store and/or other destinations such as the computer system with which the role instance is associated.

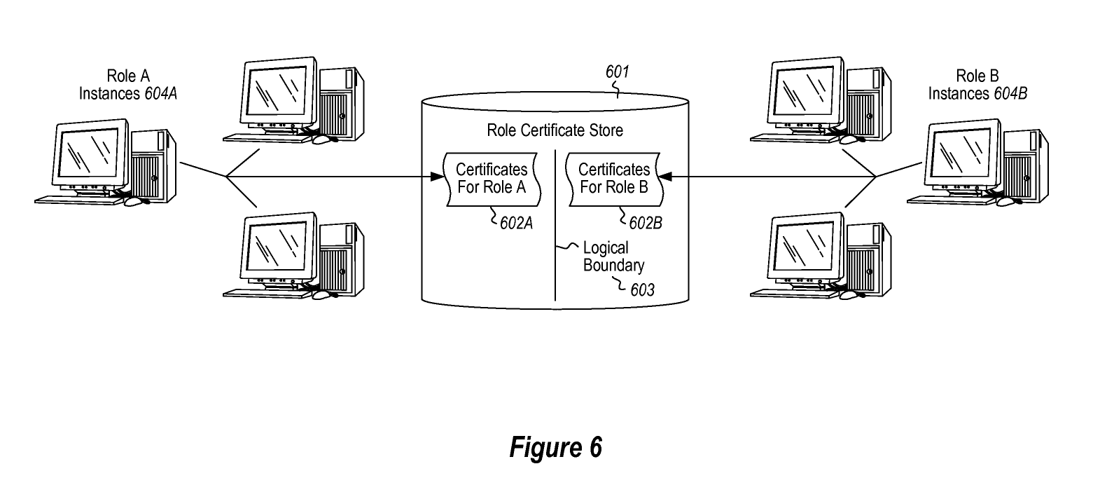

In some embodiments, as shown in FIG. 6, a role certificate store 601 may be configured to store role-based shared certificates for a plurality of different roles. For instance, role certificate store 601 may store role-based shared certificates for role A (602A) and for role B (602B). Thus, in this example, role instances 604A (i.e. a role cluster) may access shared certificates for role A and role instances 604B may access shared certificates for role B. These role-based shared certificates for both roles A and B (602A and 602B, respectively) may be stored in the same role certificate store. At least in some cases, a logical boundary may be established between each role's certificates. As such, each role can only access its corresponding shared certificates, and cannot access other role's certificates. While shown with two sets of shared certificates, it will be understood that shared certificates may be stored in the certificate store for substantially any number of roles, and that each role's certificates may be logically separated from the others. In this manner, devices (such as network devices) may be permitted to access shared certificates in a group or enterprise level, as each role instance will access the appropriate role-based shared certificate.

FIG. 4 illustrates a flowchart of a method 400 for managing role-based shared certificates using a role certificate store. The method 400 will now be described with frequent reference to the components and data of environment 100.

Method 400 includes an act of receiving a request at a role certificate store to perform one or more management actions on a role-based shared certificate stored in the role certificate store, the role certificate store being configured to store a plurality of shared certificates for at least one specified role (act 410). Role certificate store 109 may thus receive management action request 108 from a role instance or user 107 to perform a management action on at least one of the role-based shared certificates 110. The management action may include creating certificates, modifying or updating certificates and deleting certificates, among other available actions. In order to perform such actions to the certificates, the user may be authenticated using any of a variety of authentication techniques including username and password. Thus, the verifying module 106 may verify that the request was received from a user that is authorized to perform the one or more management actions (act 420). In this manner, a role instance or user 107 may be validated before being allowed to perform the requested management action 108.

Upon determining that the request was received from an authorized user or role instance, method 400 further includes an act of performing the one or more management actions on the specified role-based shared certificate at the role certificate store (act 430). Thus, once role instance or user 107 is authorized to perform management actions on the role-based shared certificates, the role instance or user may interact with the role certificate store 109 to perform the actions, including updating, modifying, creating or deleting certificates 110. In some embodiments, a user interface may be provided which allows users to manage role certificates in the role certificate store. The user interface may be presented on the computer system 101 and/or may be provided by the role certificate store or the role instance or computer system that is hosting the role certificate store. The user interface may provide buttons, forms or other elements that facilitate the management of certificates. Thus, the role certificate store 109 allows administrative users to access and manage role-based shared certificates 110 from a central location, and further allows role instances to request and receive role-based shared certificates from the same central location.

Accordingly, methods, systems and computer program products are provided which manage shared certificates of a role certificate store. Moreover, methods, systems and computer program products are provided which access and implement certificates provided by a role certificate store and manage role-based shared certificates using a role certificate store.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

I claim:

1. A computer system comprising the following:
one or more processors;
system memory;
one or more computer-readable storage media having stored thereon computer-executable instructions that, when executed by the one or more processors, cause the computing system to perform a method for managing shared certificates of a role certificate store, the method comprising the following:
an act of establishing a role certificate store, the role certificate store being configured to store one or more role-based shared certificates, each role-based shared certificate corresponding to one or more instances of a specified role;
an act of receiving a request for a role-based shared certificate from an instance of the specified role, the request being redirected from a local data store to the role certificate store;
an act of verifying that the request was received from an instance of the specified role; and
an act of sending the requested role-based shared certificate to the role instance.

2. The computer system of claim 1, wherein the role certificate store is hosted on at least one of a local computer system and a distributed, cloud computer system.

3. The computer system of claim 1, wherein the role-based shared certificate is shared by each instance associated with the role.

4. The computer system of claim 1, further comprising implementing one or more local certificates in addition to the role-based certificates, the local certificates being stored locally on the computer system to which the role instance is associated.

5. The computer system of claim 4, wherein role instances access local certificates on the local computer system to which the role instance is associated.

6. The computer system of claim 4, wherein the local certificates are at least one of node-specific and non-shareable.

7. The computer system of claim 1, wherein an interface is provided which allows users to manage role certificates in the role certificate store.

8. The computer system of claim 1, wherein at least one role instance implements a certificate not managed by the role certificate store.

9. The computer system of claim 8, wherein the implemented certificate not managed by the role certificate store includes a unique identifier that differentiates the certificate from the role-based shared certificates managed by the role certificate store.

10. The computer system of claim 1, wherein a local computer system is used as a proxy to cache the role-based shared certificate.

11. The computer system of claim 10, wherein an agent application is implemented to determine when to replace or refresh a local copy of the role-based shared certificate.

12. A computer system comprising the following:
one or more processors;
system memory;
one or more computer-readable storage media having stored thereon computer-executable instructions that, when executed by the one or more processors, cause the computing system to perform a method for accessing and implementing certificates provided by a role certificate store, the method comprising the following:
an act of a role instance sending a request for a role-based shared certificate to a role certificate store, the role certificate store being configured to store role-based shared certificates that each correspond to a specified role, the request identifying a specified role to which the role instance is associated;
an act of receiving a role-based shared certificate from the role certificate store, the role certificate store having verified that the role instance is associated with the specified role, the specified role itself being associated with the role-based shared certificate; and
an act of performing one or more role-specific functions using the role-based shared certificate.

13. The computer system of claim 12, wherein the role-specific functions include at least one function that is only available to members of that role.

14. The computer system of claim 12, further comprising instantiating a multi-role certificate store that stores role-based shared certificates for a plurality of different roles.

15. The computer system of claim 12, further comprising establishing a logical boundary between each role's certificates, such that each role can only access its corresponding shared certificates.

16. The computer system of claim 12, wherein the role certificate store is distributed over a plurality of different computer systems.

17. The computer system of claim 12, wherein the role certificate store itself is hosted on one or more role instances.

18. The computer system of claim 12, wherein network devices are permitted to access shared certificates in a group level or enterprise level, upon determining that the network devices know the path to the certificate.

19. A computer system comprising the following:
one or more processors;
system memory;
one or more computer-readable storage media having stored thereon computer-executable instructions that, when executed by the one or more processors, cause the computing system to perform a method for managing role-based shared certificates using a role certificate store, the method comprising the following:
an act of receiving a request at a role certificate store to perform one or more management actions on a role-based shared certificate stored in the role certificate store, the role certificate store being configured to store a plurality of shared certificates for at least one specified role;
an act of verifying that the request was received from a role instance that is authorized to perform the one or more management actions; and
upon determining that the request was received from an authorized role instance, an act of performing the one or more management actions on the specified role-based shared certificate at the role certificate store.

20. The computer system of claim 19, wherein the management actions comprise at least one of the following: creating certificates, updating certificates and deleting certificates.
